(19) United States
(12) Patent Application Publication
(10) Pub. No.: US 2026/0235483 A1
(43) Pub. Date: Aug. 13, 2026

(54) Fatigue Life Progression Characterization

(71) Applicant: Board of Supervisors of Louisiana State University and Agricultural and Mechanical College, Baton Rouge, LA (US)

(72) Inventors: Michael Khonsari, Baton Rouge, LA (US); Ali Mahmoudi, Baton Rouge, LA (US)

(21) Appl. No.: 19/470,669

(22) PCT Filed: Mar. 30, 2024
(86) PCT No.: PCT/US2024/022420

§ 371 Date: Sep. 29, 2025

Related U.S. Application Data
(60) Provisional application No. 63/493,207, filed on Mar. 30, 2023.

(51) Int. Cl. G01N 3/32

(52) U.S. Cl. CPC G01N 3/32; G01N 2203/0073; G01N 2203/0226; G01N 2203/0694

(57) ABSTRACT

Methods of evaluating mechanical damage are disclosed relating to fatigue life progression that include the evaluation of temperature differentials against stress dependent damage parameters for mechanical objects. Evaluation of the remaining useful life of such mechanical objects may be conducted by comparing a stabilized stressed temperature to a reference temperature for the mechanical object. The methods may be used to determine remaining useful life without benefit of a prior fatigue history.

### SPECIFICATION

This invention was made with government support under contract grant number 2052810 awarded by the National Science Foundation. The government has certain rights in the invention.

Fatigue life progression characterization methods and equipment described herein may be used in evaluation of the fatigue status, damage assessment, and remaining useful life in a variety of mechanical fatigue contexts.

### BRIEF DESCRIPTION OF DRAWINGS

FIG. 1 depicts a temperature evolution trend from a fatigue process.

FIG. 2 depicts a fatigue specimen.

FIG. 3 is a schematic diagram of surface temperature of specimens undergoing run stop cooldown procedures.

FIG. 4 depicts results of temperature measurements at different stress levels.

FIG. 5 depicts the hysteresis loop at three distinct stages of fatigue.

FIG. 6 depicts a toughness-based damage parameter.

FIG. 7 depicts the entropy-based damage parameter.

FIG. 8 depicts toughness-based damage.

FIG. 9 depicts the entropy-based damage parameter.

FIG. 10 depicts an evaluation of the remaining useful life for constant 370 MPa amplitude fatigue.

FIG. 11 depicts an evaluation of the remaining useful life for constant 360 MPa amplitude fatigue.

FIG. 12 depicts an evaluation of the remaining useful life for constant 340 MPa amplitude fatigue.

FIG. 13 depicts the remaining useful life for high-cycle fatigue at 340 MPa using the steady-state temperature results at fatigue stress of 360 MPa.

FIG. 14 depicts an evaluation of the remaining useful life for a high-to-low stress fatigue case.

FIG. 15 depicts an evaluation of the remaining useful life for a low-to-high stress case.

FIG. 16 depicts an evaluation of the remaining useful life for a low-to-high-to-low stress case.

FIG. 17 depicts an evaluation of the remaining useful life for a high-to-low-to-high stress case.

FIG. 18 depicts a configuration in which the fatigue evaluation methods described herein may be used.

### DETAILED DESCRIPTION

A reliable approach based on an entropy-damage model for assessing remaining useful fatigue life is presented. Two damage models are presented and evaluated to assess their effectiveness in predicting remaining useful life. The first model focuses on reduced toughness caused by fatigue degradation, while the second is based on accumulating entropy during fatigue loading. The entropy-based approach described in the present example employs infrared thermography to anticipate entropy accumulation and damage status. Outcomes reveal that the entropy-driven technique offers enhanced precision. Moreover, its damage growth rate remains consistent, regardless of the number of cycles leading to failure, ensuring a more stable tracking of damage evolution. The models described successfully predict the remaining useful life and can treat variable load sequencing without knowing the loading history. An extensive set of experimental results with carbon steel 1018 are presented to illustrate the utility of the approach.

Mechanical components deteriorate under cyclic loading, making them susceptible to fatigue failure. Research has demonstrated that the fatigue behavior of a material under cyclic loading can be influenced by a multitude of parameters that tend to complicate the prediction of fatigue performance.

Due to external actuation, components experience self-heating that manifests itself in the rise in temperature due to unrecoverable heat generation. The associated increase in surface temperature is directly proportional to the applied load: The higher the fatigue load, the hotter is the surface temperature. Descriptions herein rely on a variety of terms and equations and the following list of terms may be used as a general reference:
A Thermodynamic force associated with the internal state parameter
FFE Fracture Fatigue Entropy
C Material's constant
cₚ Specific heat capacity
N_{f} Number of cycles to failure
\vec{q} Heat flux across the boundary
R_{θ} Rate of temperature change
R_{θ}_{ₒ} Rate of temperature change at the beginning of the fatigue process
R_{θ}_{_{f}} Rate of temperature change before fracture
R_{θ}_{_{N}} Rate of temperature change after N cycles
t Time
T Temperature
U_{T}_{ₒ} Static fracture toughness of pristine specimen
U_{T}_{_{N}} Static fracture toughness of fatigued specimen after N cycles
Vᵢ Internal state parameter
W_{P} Plastic strain energy
Y Conjugated force of internal variable
γ Non-negative entropy production
γ_{f} Accumulated entropy up to fracture
γ_{N} Accumulated entropy after N cycles
ε^{p} Plastic strain
θ Temperature rise
θ₀ Temperature rise of undamaged specimens
θ_{f} Temperature rise at the final stage of fatigue
θ_{N} Temperature rise after N cycles
θₛ Temperature rise at steady state
ρ Density
σ Stress
σ_{α} Stress amplitude
ω_{cr} Critical damage parameter
ω_{E,N} Entropy-based damage parameter after N cycle
ω_{T,N} Toughness-based damage parameter after N cycle

Typically, the surface temperature of a material undergoing fatigue increases rapidly at the beginning of the fatigue process and reaches a steady state for most of the fatigue duration before it experiences a sudden increase near the fracture.

Entropy may be used as an index for different types of degradation. The accumulation of entropy generation up to failure, called fracture fatigue entropy (FFE), remains constant under different types of loading. FFE is a material property independent of loading parameters, geometry, and environmental conditions. The entropy framework can be used for accelerating the testing procedure to predict the fatigue life and construct the S-N curves. Furthermore, these models can predict the temperature evolution during fatigue and demonstrate how the temperature rise can be utilized to predict accumulated damage during fatigue. The rate of temperature rise at the beginning of the fatigue may also be used to estimate the remaining fatigue life.

In the present study, a robust method was developed that directly uses the temperature rise to quantify damage accumulation during cyclic loading. Two damage models are introduced to gain further insight into the efficacy of predicting the accumulated fatigue degradation via temperature rise. The remaining useful life predictions (RUL) are authenticated via extensive experimental results. The RUL approach covers low- and high-cycle fatigue, constant- and variable-loading sequences and does not require the knowledge of the prior loading history of a pre-fatigued specimen.

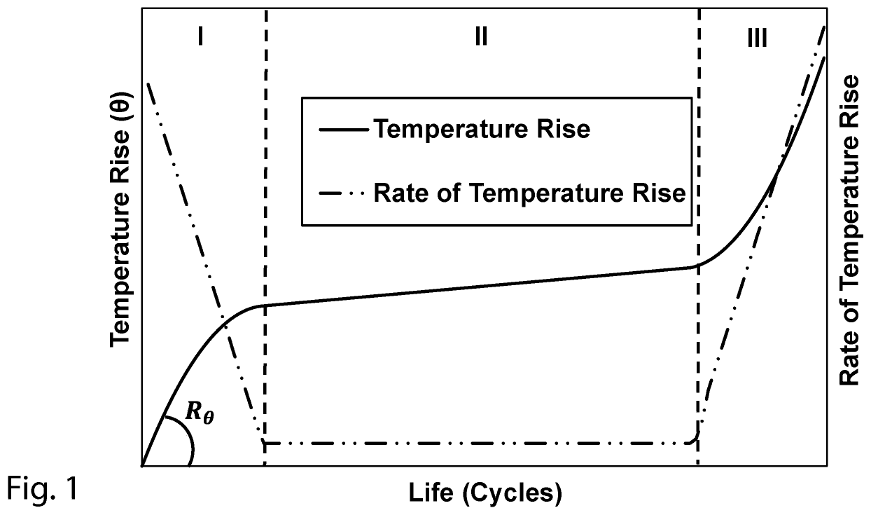

Fatigue is an irreversible degradation process that results in the dissipation of heat. Thus, a thermodynamic framework is required to investigate the internal heat generation and changes in temperature during cyclic loading. FIG. 1 shows a typical trend of temperature evolution during the fatigue process. The temperature rises rapidly at the beginning of the cyclic loading (Phase I). It stabilizes for most of the fatigue process (Phase II) before experiencing a sudden increase just prior to fracture (Phase III). FIG. 1 also provides the rate of temperature rise at different stages of the fatigue process. The slope of temperature rise decreases as temperature increases in Phase I, then it stabilizes in Phase II before a sharp rise in Phase III. In Phase II of the fatigue process, the temperature is nearly constant at low-stress levels or increases gradually with a low constant rate at high-stress levels.

To investigate irreversible fatigue degradation, the second law of thermodynamics can be used. For a material undergoing fatigue, the 2^{nd} law is expressed by the following equation:

$$\dot{γ} = \frac{σ : {\dot{ε}}_{p}}{T} + \frac{A {\dot{V}}_{k}}{T} - \frac{\vec{q} \cdot ∇ T}{{T}^{2}} \geq 0 \qquad ( 1 )$$

where \dot{γ} is the non-negative entropy generation rate and T is the temperature in Kelvin-scale. σ denotes the applied stress and εₚ is the plastic strain. A is the thermodynamic force associated with the internal state parameter Vᵢ. \vec{q} represents the heat flux across the boundary. For metals, the energy associated with the internal parameters (A\dot{V}ₖ) is only 5-10% of plastic strain energy (\dot{W}ₚ=σ:\dot{ε}ₚ) and can be neglected for simplicity. Also, entropy generation owing to heat conduction, the last term in Eq. 1, is negligible. Therefore, the entropy generation associated with the damaging energies can be obtained as:

$${γ}_{f} = {\int }_{0}^{{t}_{f}} \frac{{\dot{W}}_{p}}{T} d t = {\int }_{0}^{{t}_{f}} \frac{σ : {\dot{ε}}_{p}}{T} d t \qquad ( 2 )$$

The accumulated entropy up to fracture for a material undergoing fatigue is nearly constant and is independent of loading conditions, and the fracture occurs when γ_{f} reaches the entropy threshold of a material, i.e., the so-called fracture fatigue entropy (FFE).

The first damage parameter is developed based on the toughness reduction during fatigue. One damage parameter to describe the fatigue behavior of metals based on changes in static fracture toughness during cyclic loading is:

$${ω}_{T , N} = - 1 - \frac{{U}_{{T}_{N}}}{{U}_{{T}_{0}}} \qquad ( 3 )$$

where ω_{T,N} is the accumulated damage to cycle Nth, U_{T}_{ₒ} is the static fracture toughness of the pristine specimen at the beginning of the fatigue test, and U_{T}_{_{N}} is the static fracture toughness of fatigued specimen after N cycles. That damage parameter can be defined as:

$${ω}_{T , N} = - \frac{{ω}_{c r}}{ln ( {N}_{f} )} ln ( 1 - \frac{N}{{N}_{f}} ) \qquad ( 4 )$$

where ω_{cr} can be calculated using:

$${ω}_{c r} = 1 - \frac{{σ}_{a}^{2}}{2 E {U}_{{T}_{0}}} \qquad ( 5 )$$

For a wide range of stress amplitude (σₐ), ω_{cr}≈1. This damage parameter may be further understood based on the rate of temperature changes (R_{θ}) at different accumulated cycles and suggested a test procedure described as follows. After reaching a steady state, the fatigue test is stopped at different stages and the specimen is allowed to cool down to the ambient temperature, and then the fatigue test is resumed. At each stage, the temperature rise changes and in Phase II as depicted in FIG. 1 the temperature rise grows linearly with an increase in the number of cycles. The damage parameter in Eq. 4 may be modified as follows:

$${ω}_{T , N} = - \frac{1}{ln ( {N}_{f} )} ln ( 1 - \frac{{R}_{{θ}_{N}} - {R}_{{θ}_{0}}}{{R}_{{θ}_{f}} - {R}_{{θ}_{0}}} ) \qquad ( 6 )$$

where R_{θ0}, R_{θf} and R_{θN} are temperature gradients at the beginning of the fatigue process, the onset of fracture, and after N fatigue cycles, respectively. The damage parameter can also be defined based on the temperature rise, rather than R_{θ}, at the stabilized phase of fatigue as follows:

$${ω}_{T , N} = - \frac{1}{ln ( {N}_{f} )} ln ( 1 - \frac{{θ}_{N} - {θ}_{0}}{{θ}_{f} - {θ}_{0}} ) \qquad ( 7 )$$

where θ₀ is the stabilized temperature of the undamaged specimen. θ_{N} is the temperature rise of a specimen subjected to N load cycles. And θf is the temperature rise of a specimen at its final stage of fatigue before a sudden increase in temperature.

The second damage parameter introduced in this study is the normalized entropy generation based on the FFE concept defined as follows.

$${ω}_{E , N} = \frac{{γ}_{N}}{F F E} \qquad ( 8 )$$

where ω_{E,N} and γ_{N} are the accumulated damage and entropy at the N^{th} cycle. In Eq. 8, ω_{E,N} represents the expired capacity of the material caused by entropy generation. This parameter increases linearly during the fatigue process from 0 to 1. As the stabilized temperature also increases approximately linearly during the fatigue process, the damage parameter in Eq. 8 can be written as:

$${ω}_{E , N} = \frac{{θ}_{N} - {θ}_{0}}{{θ}_{f} - {θ}_{0}} \qquad ( 9 )$$

To assess the efficacy of the proposed approach, a set of fatigue tests at different stress amplitudes was performed on carbon steel 1018. The material composition, test method, equipment, and experimental procedure are described next.

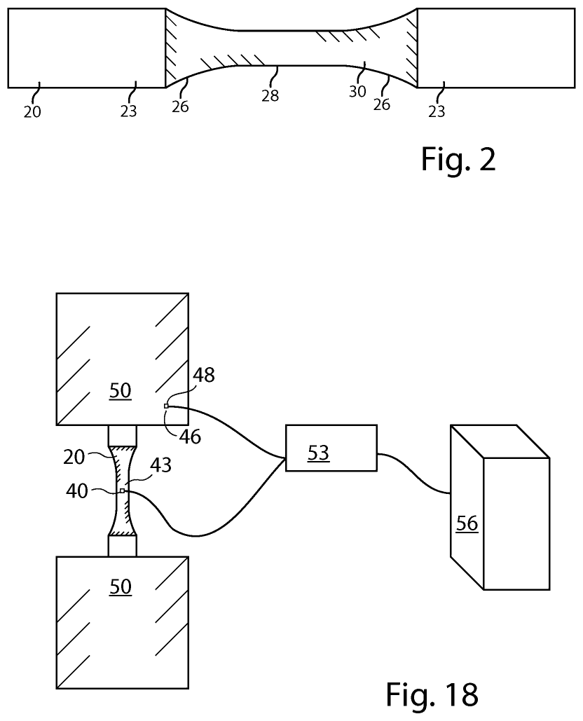

The chemical composition and mechanical, physical, and thermal properties of carbon steel 1018 are shown in Table 1 and Table 2. Cylindrical dog-bone specimens are designed and manufactured based on ASTM E 466-15 for fatigue testing. The surface of the specimens was polished using sandpaper. The gauge section of specimens was also sprayed with a thin black layer to increase the thermal emissivity. FIG. 2 shows a designed, polished, and painted specimen 20 with ends 23 that are 25 mm long and 12.5 mm in diameter, a central barrel 28 that is 12.6 mm long and 5.1 mm in diameter, and two tapered sections 26 extending between the ends 23 and the central barrel 28. The tapered sections 26 have a radius of 30 mm. The coated area 30 encompasses the tapered sections 26 and the central barrel 28.

TABLE 1
The chemical composition of carbon steel 1018

| Material | C | Fe | Mn | S | P |
|---|---|---|---|---|---|
| CS 1018 | 0.14-0.2 | 98.81-99.26 | 0.6-0.9 | 0.05 Max | 0.04 Max |

TABLE 2
Mechanical, physical, and thermal properties of carbon steel 1018

| Material | Units | CS 1018 |
|---|---|---|
| Density (ρ) | Kg/m³ | 7870 |
| Thermal conductivity (k) | W/(m · K) | 51 |
| Specific heat capacity (C.) | J · kg⁻¹ · K⁻¹ | 486 |
| Young's modulus (E) | GPa | 199 |
| Ultimate Strength (σᵤ) | MPa | 510 |
| Yield strength (σ_{y}) | MPa | 395 |

Fatigue tests were carried out using a testing machine with a maximum 25 kN axial load capability. The tail ends of the specimens were gripped with sufficient gripping pressure to avoid slippage between the specimen and the gripping jaws of the machine. A MIKRON M7500 infrared (IR) camera was utilized to record the surface temperature of the specimens during fatigue tests. The IR camera has a temperature range capability between 0-500° C., a sensitivity of 0.08° C. at 30° C., an accuracy of ±2% of reading, and a resolution of 320×240 pixels.

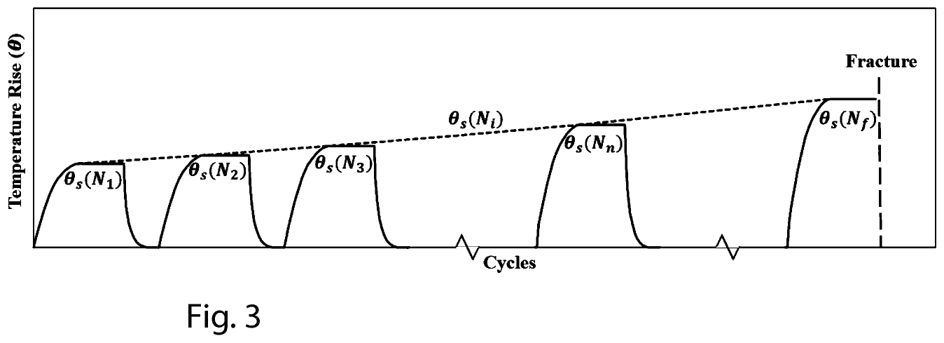

Load-controlled uniaxial fatigue tests were performed at different stress levels, a load ratio of −1, and a frequency of 10 Hz. The experiments follow a repeating Run-Stop-Cooldown (RSC) process as described next. Referring to FIG. 1, the specimen at ambient temperature is subjected to the fatigue load to reach a steady state (Phase II). Test results show that the rate of temperature rise stabilizes after running 5000 fatigue cycles. Therefore, the intervals of 5000 cycles are selected to record the temperature rise. At the end of each interval, the fatigue test is stopped, and the specimen is allowed to cool down to the ambient temperature. Then the same fatigue load is applied to the specimen and the experiment is continued until a new stabilized temperature is reached. This procedure is repeated several times up to fracture to evaluate the relation between the stabilized temperature and the number of fatigue cycles. A schematic diagram of the surface temperature of specimens undergoing repeating RSC procedures is shown in FIG. 3. It is worth mentioning that the temperature is assumed to be uniform in the radial direction. This assumption is grounded in the presence of uniform heat generation within the gauge section, owing to the absence of stress concentration and the high thermal conductivity of steel materials. These combined factors substantiate the rationale for considering a uniform radial temperature.

The temperature measurements are utilized to investigate the behavior of CS 1018 specimens undergoing tension-compression fatigue loading. The evolution of stabilized temperature during cyclic loading is used to obtain the damage evolution throughout the fatigue process. The methodology for predicting the remaining life of a pre-fatigued specimen below shows how the entropic concept and the concept of damage continuity can be used to assess the remaining useful life of a pre-fatigued specimen without knowing the loading history. Also presented are a series of predictions and experimental verifications to illustrate the efficacy of the approach to variable loading sequences.

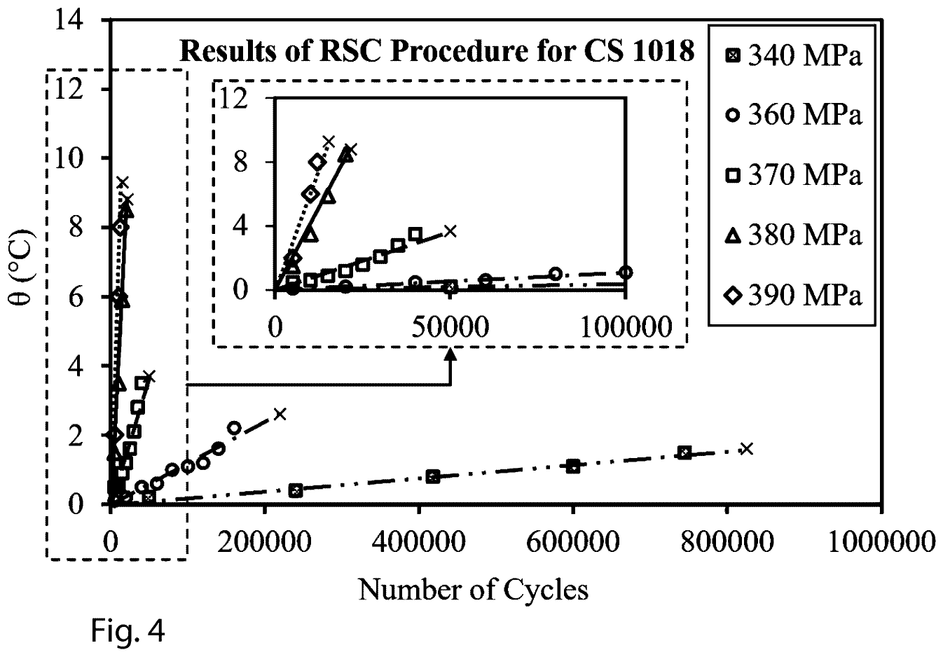

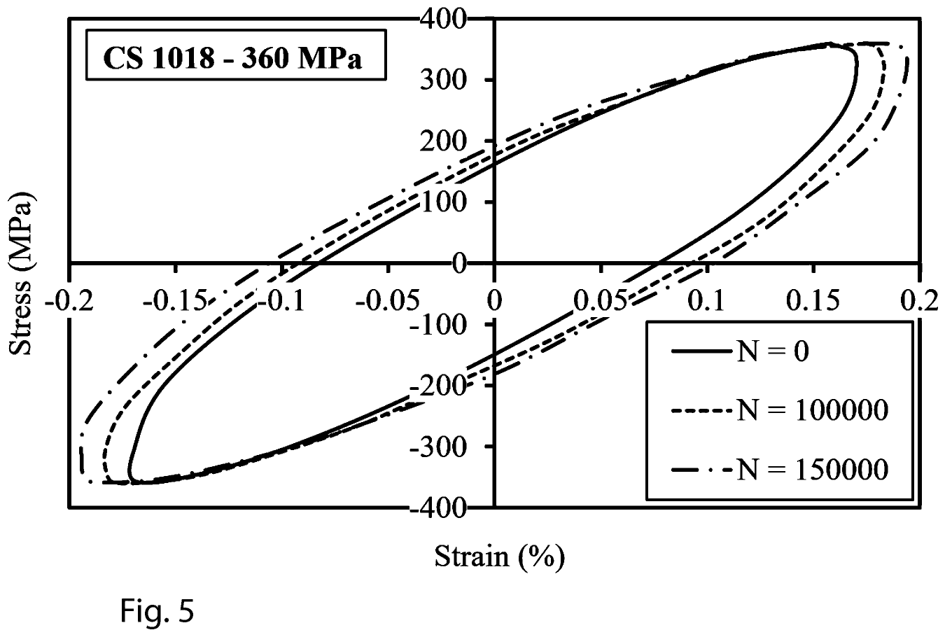

FIG. 4 shows the results of temperature measurements at different stress levels. It depicts the variation of temperature rise during a Run-Stop-Cooldown (RSC) fatigue procedure of CS 1018 at different stress levels and frequency of 10 Hz. As described earlier, following the RSC procedure, the fatigue tests are stopped at the steady-state phase, and the temperature rise is measured. Then, the specimens are allowed to cool down to the ambient temperature before resuming the fatigue procedure. The energy associated with the plastic strain—the main source of energy dissipation in metal fatigue—is directly related to the stress level. As can be seen in FIG. 4, the higher the temperature rises, the shorter the fatigue life becomes, indicating that at higher loads, the material reaches its maximum capacity of entropy generation faster than at lower loads. Furthermore, the progressive temperature rise occurs as the fatigue loading persists. This phenomenon can be attributed primarily to the increased generation of plastic strain energy resulting from material softening, leading to greater energy dissipation. In FIG. 5, the expansion of the hysteresis loop, which serves as an indicator of energy dissipation, is depicted at three distinct stages of fatigue under the stress level of 360 MPa. The temperature rise during fatigue of CS 1018 specimens can be estimated using the following linear equation.

$${θ}_{N} = C N + {θ}_{0} \qquad ( 10 )$$

where θ_{N} is the temperature rise of a specimen subjected to N load cycles. C is a constant and θ₀ is the temperature rise of an undamaged specimen. C and θ₀ depend on the material property, loading conditions, and geometry. The values of parameters C and θ₀ for the presented test setup are given in Table 3, along with the fatigue life at different stress levels.

TABLE 3
Fatigue life and parameters C, θ₀ and θ_{f} for
temperature rise at different stress levels

| Stress Level | Number of cycles | | θ₀ | θ_{f} |
|---|---|---|---|---|
| (MPa) | to failure (N_{f}) | C | (° C.) | (° C.) |
| 340 | 825,200 | 1.9147 × 10⁻⁶ | 0.02 | 1.6 |
| 360 | 219,800 | 1.1507 × 10⁻⁵ | 0.05 | 2.55 |
| 370 | 49,900 | 7.3146 × 10⁻⁵ | 0.11 | 3.65 |
| 380 | 21,500 | 4.0792 × 10⁻⁴ | 0.25 | 8.85 |
| 390 | 15,300 | 6.0784 × 10⁻⁴ | 0.36 | 9.35 |

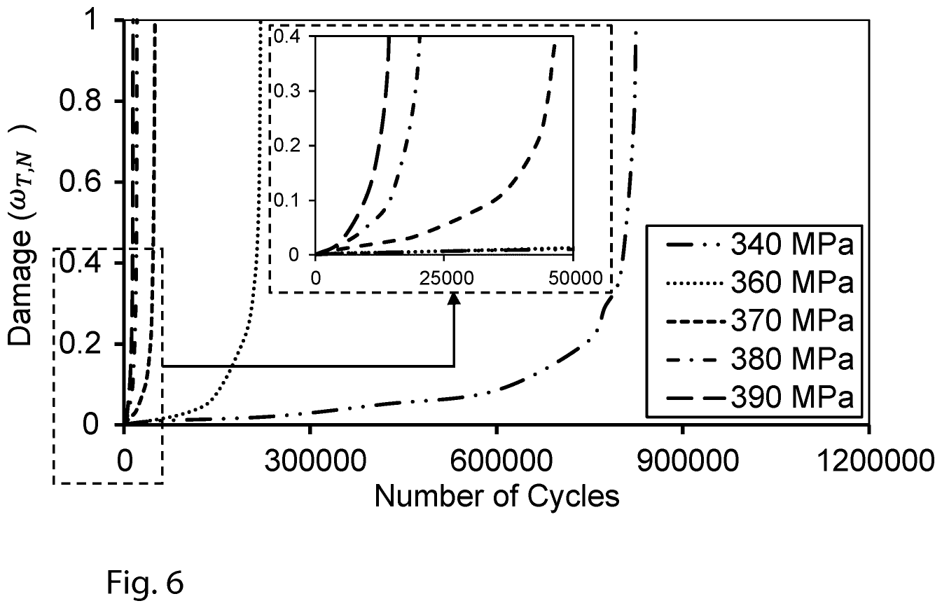

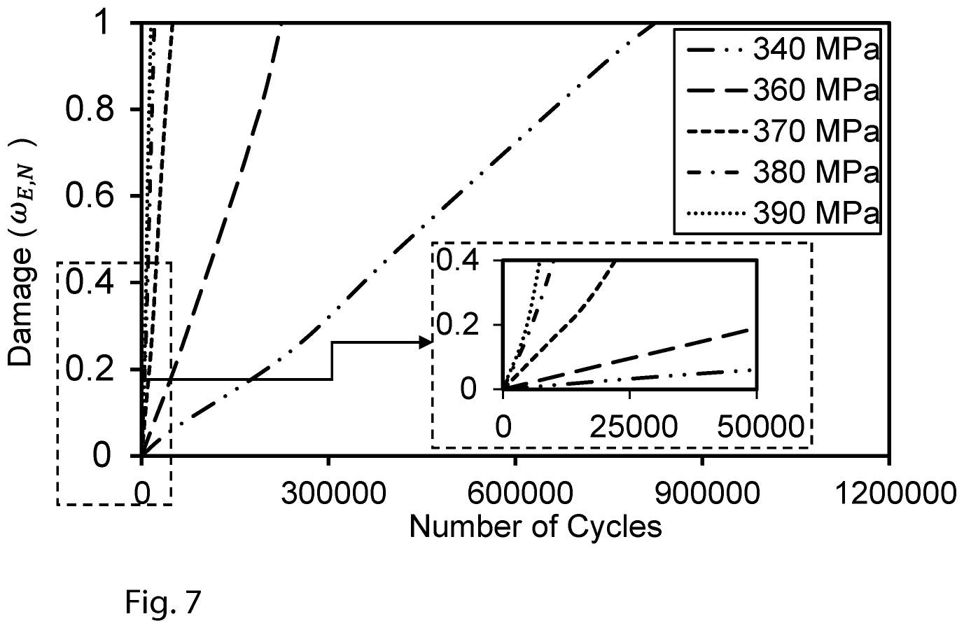

FIGS. 6 and 7 show the evolution of damage parameters, ω_{T,N} and ω_{E,N}, throughout the fatigue process at stress levels of 340, 360, 370, 380 and 390 MPa. As shown in FIG. 6, the toughness-based damage parameter (ω_{T,N}), as defined in Equation 7, has a gradual increase in the first 70% of fatigue life to reach the value of 0.1. Then, it sharply increases in the rest of life to fracture to reach the value of 1. In this damage parameter, the rate of evolution of damage at different stress levels depends on the normalized life (N/N_{f}). As an example, at 360 MPa, the damage reaches 0.1 after 72% of life and at 390 MPa, the same value is reached after 65% of expended life. On the other hand, the entropy-based damage parameter (ω_{E,N} in FIG. 7), defined based on Eq. 9, has a nearly linear gradual increase to fracture. In the entropy-based damage parameter, the rate of changes of damage at different stress levels is independent of normalized life (N/N_{f}), which means the damage at different stress levels reaches the same values if the expended normalized lives are equal.

FIGS. 6 and 7 show that quantifying the toughness-based damage (ω_{T,N}) is more sensitive compared to the entropy-based damage (ω_{E,N}). As an example, at stress levels of 360 MPa, the damage values at expended life of 50,000 and 100,000 cycles (22.5% and 45% of life) are 0.015 and 0.03 for ω_{T,N} and 0.225 and 0.45 for ω_{E,N}, respectively. This means that even 1 percent of change in ω_{T,N} translates to a large difference in estimation of the expended life, which can cause a significant error in the estimated remaining useful life. In contrast, the same amount of error in predicting ω_{E,N} causes only 1% of error in estimated remaining useful life.

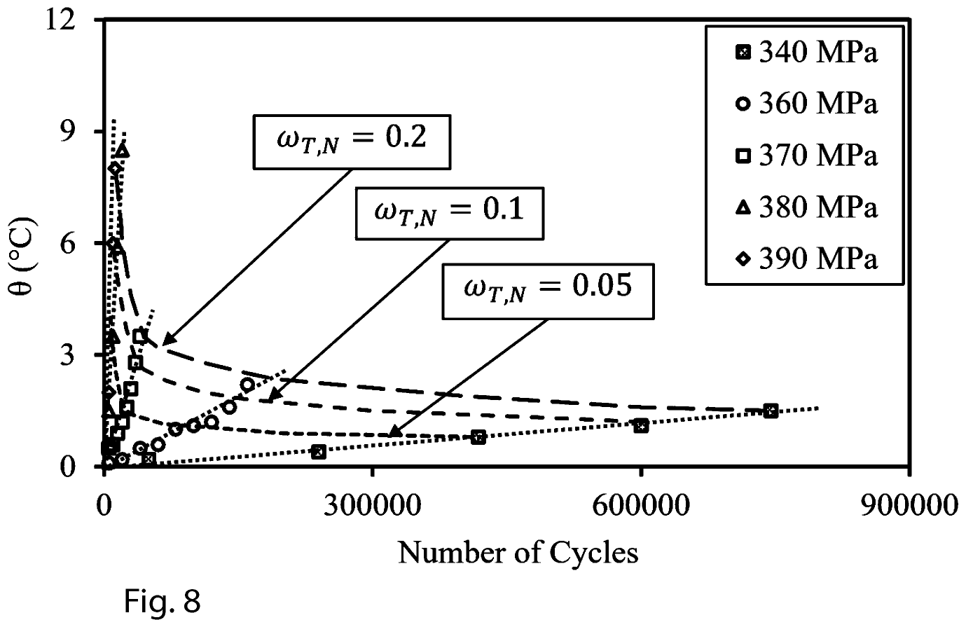

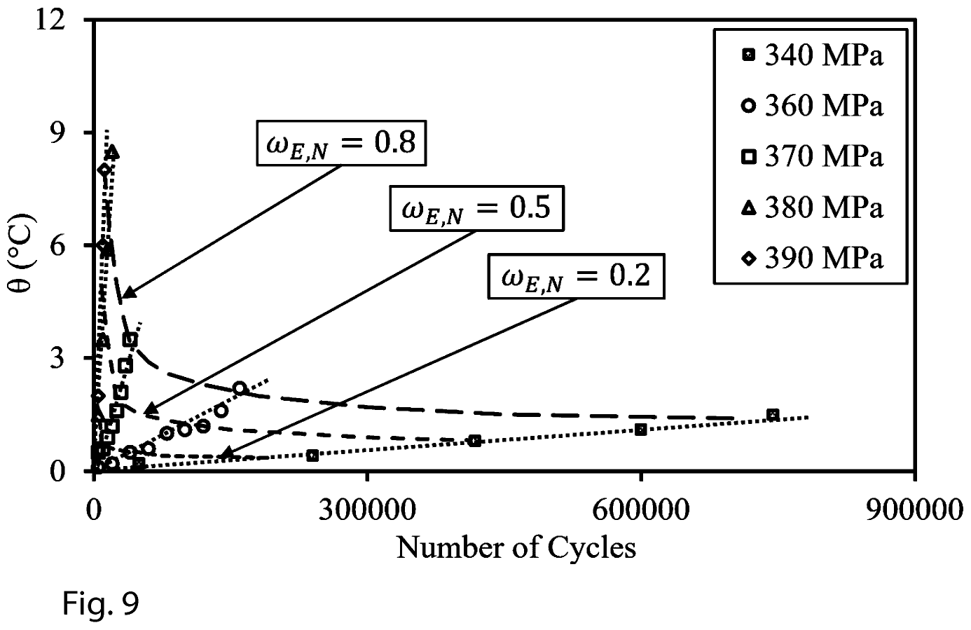

FIGS. 8 and 9 show the iso-damage curves on the temperature-life graph at different stresses. The dashed curves connect the points with equal damage values at different stress levels. FIG. 8 indicates that if the toughness-based damage (ω_{T,N}) is used, the same damage occurs at different normalized life (N/N_{f}). For example, at 360 MPa the damage of 0.05 occurs after 121,000 cycles which is equivalent to 55% of fatigue life, and the same damage occurs after 404,000 cycles at 49% of fatigue life at 340 MPa. While FIG. 9 shows that in the entropy-based damage parameter (ω_{E,N}), the same damage values are corresponding to the same normalized life. As an example, the damage values of 0.5 occurs after expending approximately 50% of life at 360 and 340 MPa.

FIGS. 6-9 and the explanations presented in herein show that quantifying the damage using entropy-based damage (ω_{E,N}) is more convenient and less prone to inaccuracy. ω_{E,N} has a nearly linear gradual increase up to fracture which means the same expended normalized life at different stress levels corresponds to approximately equal damage values. Also, contrary to the ω_{T,N}, the small error in prediction of ω_{E,N} does not cause large differences between estimated and actual remaining useful life. Therefore, in this study, the entropy-based damage parameter (ω_{E,N}) is used to estimate the damage values and corresponding remaining useful life at different fatigue cases.

A methodology for predicting the remaining life of a pre-fatigued specimen is presented below. The approach presented is applicable regardless of whether the history of loading is known or not. The concept of continuity of damage is used in this section to find the remaining useful life of a material experiencing fatigue. In this concept, the damage is idealized as a continuous state variable that accumulates until fracture. In this approach, knowing the history of loading is not necessary. The damage in the specimen can be evaluated by conducting a single fatigue test at any of the characterized stress levels presented in previous sections.

A generalized method for obtaining the remaining useful life of a pre-fatigued material may proceed according to the following steps. First, measure the temperature rise during the steady-state phase (θₛ) at one of the specific fatigue stress levels presented above. Second, calculate the damage value corresponding to the current condition of the material using Eqs. 7 or 9. (Eq. 9 is used for ω_{E,N}, the entropy-based damage parameter, which has some advantages as discussed. The information provided in Table 3 is then used to calculate the damage value.) Third, obtain the equivalent expended life of the material at any stress level using the damage parameter (N_{eq}=ω_{E,N}*N_{f}). Finally calculate the remaining useful life (RUL) of the material (RUL=N_{f}−N_{eq}).

Seven different fatigue cases, three constant amplitudes, and four variable amplitudes, including high-to-low, low-to-high, low-to-high-to-low, and high-to-low-to-high stresses, are presented with experimental verifications to investigate the application of this method. A summary of the results is presented in Table 4.

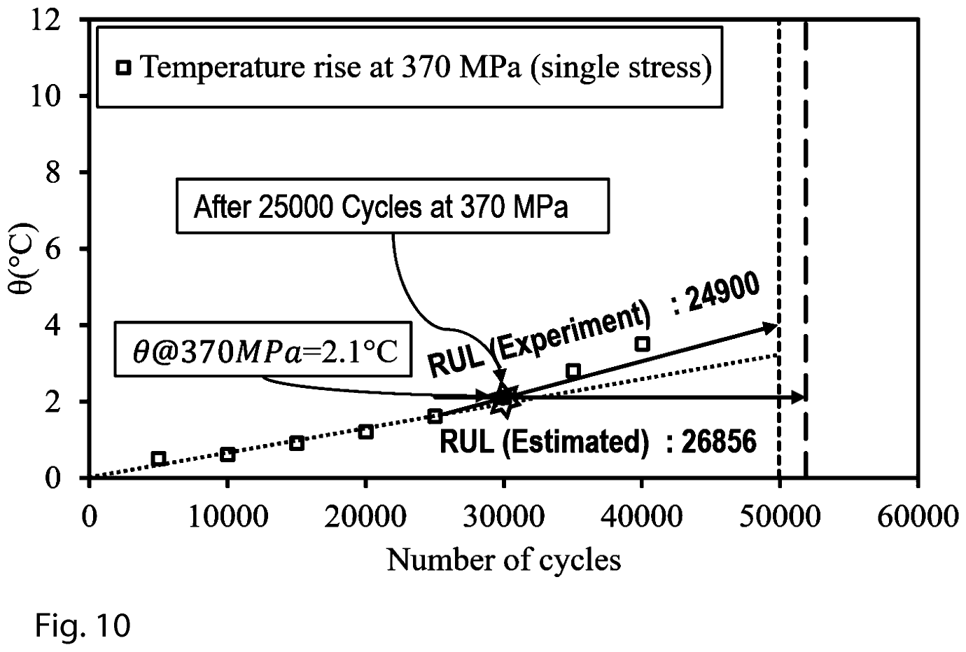

In Case I, constant loading at 370 MPa stress amplitude (low-cycle fatigue) was tested, illustrating how the remaining useful life of a fatigued specimen subjected to a constant amplitude load can be estimated. Consider a pre-fatigued specimen that operated for 25,000 cycles at 370 MPa and the fatigue test is stopped, and the specimen cooled down to the ambient temperature. To estimate the remaining life, a single fatigue test at the same stress is carried out to reach the steady-state temperature. FIG. 10 depicts an evaluation of the remaining useful life for constant 370 MPa amplitude fatigue. The squares in FIG. 10 are the same points in FIG. 4 at the single stress of 370 MPa obtained via the RSC procedure. The rise of stabilized temperature after 5,000 cycles is 2.1° C., which is equal to the damage of ωE,N 0.562 based on Eq. 9 and data provided in Table 3 for θ₀ and θ_{f} at 370 MP. It means that the remaining useful life of the specimen is 43.8% of fatigue life at 370 MPa. Considering the number of cycles needed to obtain 0, the estimated remaining useful life is 26,856 cycles. The experiment continued to fracture, and results showed that the prediction was slightly higher than the experimental results for this case, 24,900 cycles, with an error of less than 8%. Note that the information on the pre-fatigued history (i.e., 25,000 cycles) was not used in predictions of RUL.

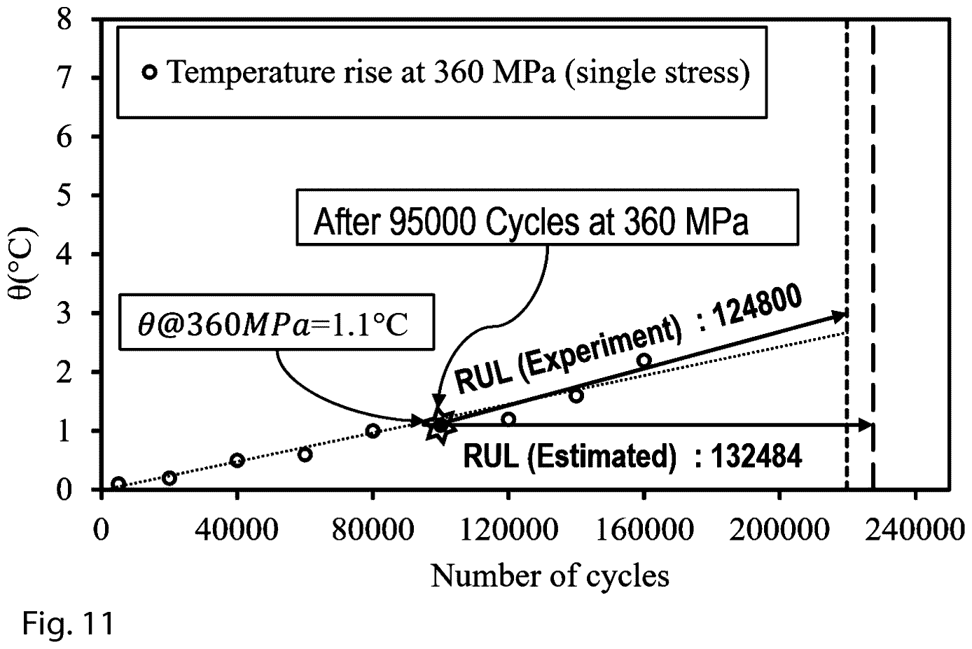

In case II constant loading at 360 MPa stress amplitude (mid-cycle fatigue) was conducted presenting an example where a specimen is subjected to 95,000 cycles at 360 MPa before stopping the fatigue test. When the temperature of the specimen stabilizes, a single fatigue test at the same stress level is carried out. FIG. 11 depicts an evaluation of the remaining useful life for constant 360 MPa amplitude fatigue. The circles in FIG. 11 are the same stabilized temperatures at the single stress 360 MPa in FIG. 4. The temperature stabilized after 5,000 cycles with a rise of 1.1° C. Using Eq. 9 and data provided in Table 3 for θ₀ and θ_{f} at 360 MP, the damage is calculated to be ω_{E,N}=0.42. This suggests that 58% of life is remaining. Considering the number of cycles needed to obtain temperature rise, the estimated remaining useful life is 132,484 cycles.

To confirm the validity of predictions, the experiment was allowed to run to fracture and the number of cycles to failure was recorded. The obtained results from experiments show that the RUL is 124,800 cycles. Therefore, the error between the estimated and experimental results was less than 7%.

In case III constant loading at 340 MPa stress amplitude (high-cycle fatigue) was conducted. In high-cycle fatigue, the temperature rise is small, and measuring the exact change in temperature can be difficult. Therefore, two different approaches can be used to find the damage value and the remaining useful life. In the first approach, the damage evaluation process is done at the same stress levels as the fatigue test and in the second approach, a stress level with higher temperature rises is utilized to evaluate the damage. Both approaches are discussed here for a specimen undergoing a high-cycle fatigue test at 340 MPa. The test is stopped after 240000 load cycles and the specimen was cooled down to the ambient temperature.

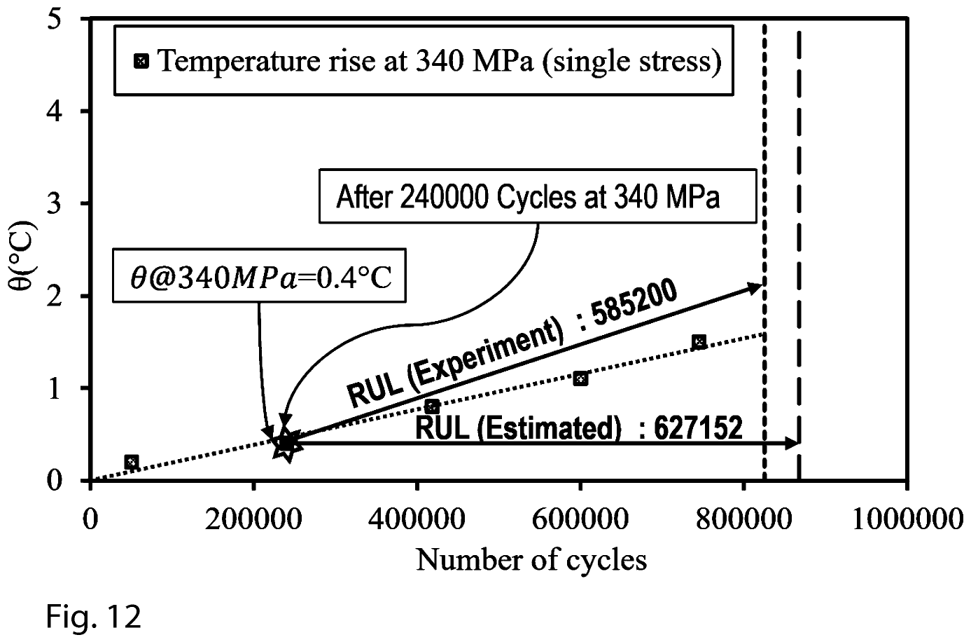

Using the first approach, a single fatigue test at the same stress level (340 MPa) is carried out. FIG. 12 depicts an evaluation of the remaining useful life for constant 340 MPa amplitude fatigue. The squares in FIG. 12 are the results of steady-state temperature rise shown in FIG. 4 for single stress 340 MPa. The stabilized temperature rises 0.4° C. after 5,000 cycles. Based on Eq. 9 and the data provided in Table 3 for 60 and θ_{f} at 340 MP, this values of temperature rise is equal to the damage of ω_{E,N}=0.24. Thus, the remaining useful life of the specimen is 76% of fatigue life at 340 MPa, which is equal to 627,152 cycles. The experiment was continued until the specimen fractured. The number of cycles to fracture was 585200, showing an error of less than 8% between the experiments and predicted results.

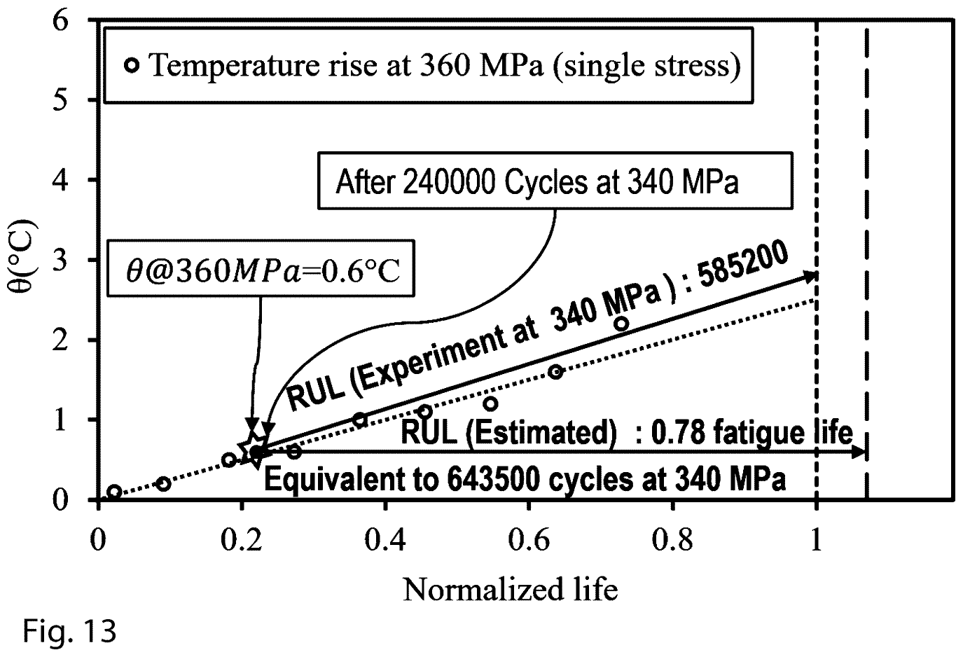

The second approach uses a higher stress level to find the damage value and its corresponding RUL. Here, the stress level of 360 MPa is used as reference stress to evaluate the damage. FIG. 13 depicts the remaining useful life for high-cycle fatigue at 340 MPa using the steady-state temperature results at fatigue stress of 360 MPa. FIG. 13 shows the steady-state temperature rise versus normalized life at 360 MPa. The fatigue test is carried out at 360 MPa and the temperature rises 0.6° C. after 5,000 cycles, which is equivalent to the damage value of ω_{E,N}=0.22 based on Eq. 9 and the data provided in Table 3 for θ₀ and θ_{f} at 360 MP. This means that 78% of specimen's life remains. That is equivalent to 643,500 cycles at 340 MPa. The error between the predicted and experimental results in this approach is less than 10%.

These results show that the damage is continuous and accumulates during fatigue even if the fatigue stress is changed. It implies that for high-cycle fatigue wherein the values of temperature rise are small, the results of another fatigue stress can be used to determine the RUL. A fatigue test that could induce an adequate temperature rise can be applied to the pre-fatigued component to measure the steady-state temperature and determine the RUL.

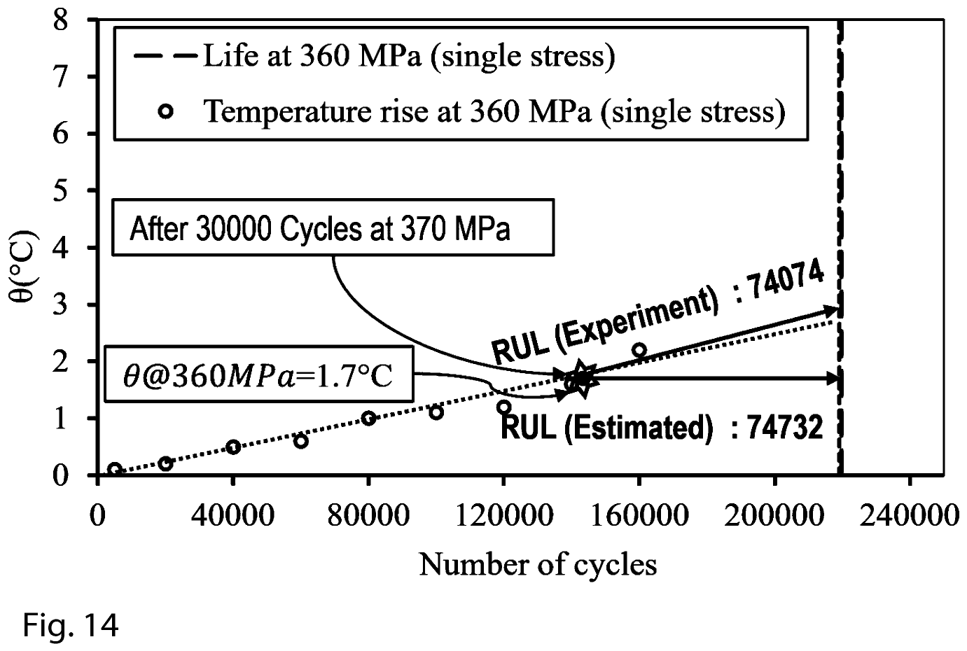

In case IV variable loading from high-to-low stress (from 370 to 360 MPa) was evaluated. After 30,000 cycles at 370 MPa, the fatigue stress is changed to 360 MPa. FIG. 14 depicts an evaluation of the remaining useful life for a high-to-low stress fatigue case (370 to 360 MPa). The circles in FIG. 14 correspond to the stabilized temperature at the single stress of 360 MPa in FIG. 4. The temperature stabilized after 5,000 cycles with a rise of 1.7° C., which is equal to the damage of ω_{E,N}=0.66. This means that 34% of life is remaining. Considering the number of cycles needed to obtain temperature rise, the remaining useful life at the beginning of the second fatigue stress is 74,732 cycles. Tests were continued at 360 MPa until fracture. The experimental number of cycles to fracture was 74,074. The estimated RUL is very close to the experimental result, with an error of less than 1%.

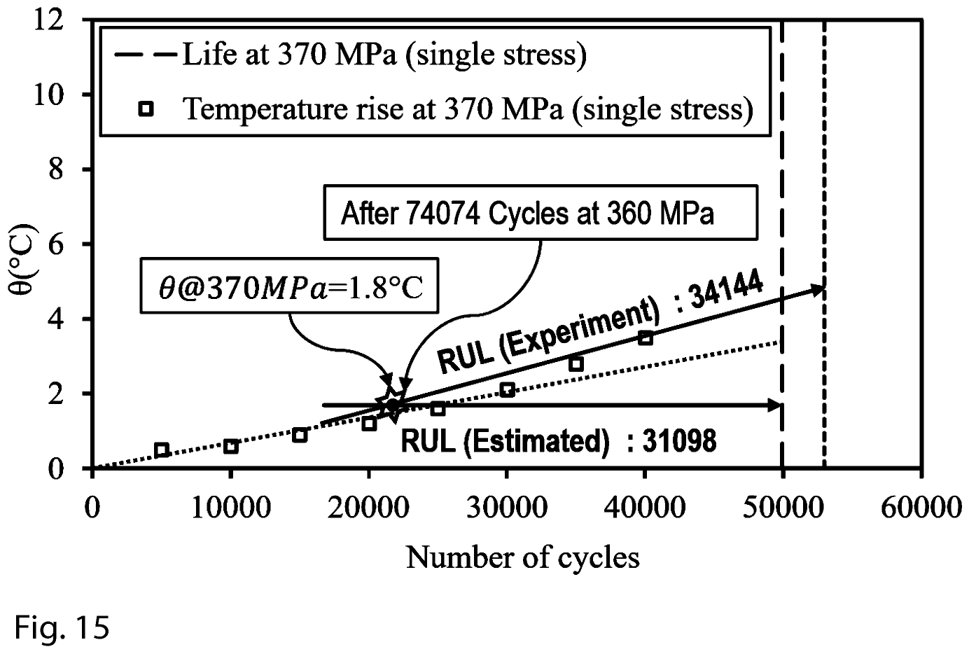

In case V variable loading from high-to-low stress (from 360 to 370 MPa) was evaluated. A variable amplitude load is applied to the CS 1018 specimen from a low- to high-stress fatigue. The fatigue load is changed to 370 MPa after 74,074 load cycles at 360 MPa. FIG. 15 depicts an evaluation of the remaining useful life for a low-to-high stress case (360 to 370 MPa). The square points in FIG. 15 are the same results presented in FIG. 4 for changes in stabilized temperature at the single stress amplitude of 370 MPa. At the second amplitude load (370 MPa), the temperature change is measured to be 1.8° C. after 5,000 cycles. This is equal to the damage of ω_{E,N}=0.477, revealing that 52.3% of fatigue life is remaining. Taking into account the number of cycles expended to reach the stabilized temperature and considering the fatigue life at the single stress of 370 MPa (49,900 cycles), the predicted RUL is 31,908. The experimental result for RUL is 34,144 cycles, which indicates the error between the prediction and experiment is less than 9%.

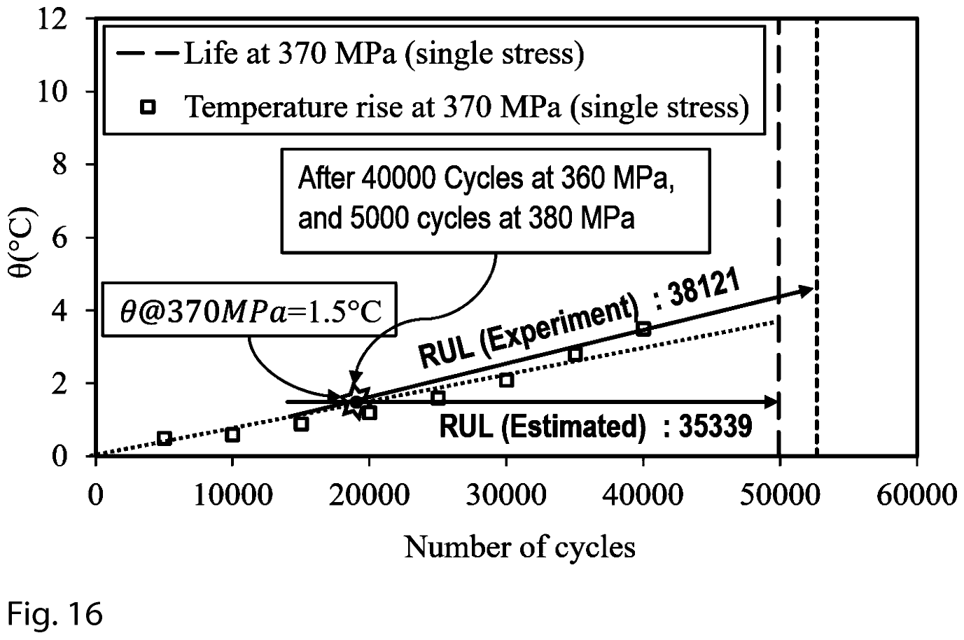

In case VI. Variable loading from low-to-high-to-low stress (from 360 to 380 to 370 MPa) was evaluated. The specimen was subjected to 40,000 cycles at 360 MPa and 5,000 cycles at 380 MPa, before reducing the stress to 370 MPa. FIG. 16 depicts an evaluation of the remaining useful life for a low-to-high-to-low stress case (360 to 380 to 370 MPa). The circle points in FIG. 16 are the results of temperature rise at the single fatigue stress of 370 MPa. The temperature rise after 5000 cycles at 370 MPa is measured to be 1.5° C., which is equivalent to the damage of ω_{E,N}=0.392. Therefore, considering 5,000 cycles to reach the stabilized temperature, the estimated RUL at the beginning of the third fatigue stress is 35,339. The experimental result for RUL is 38,121 cycles. The predicted results are conservative and the difference between the estimated and the experimental results is less than 8%.

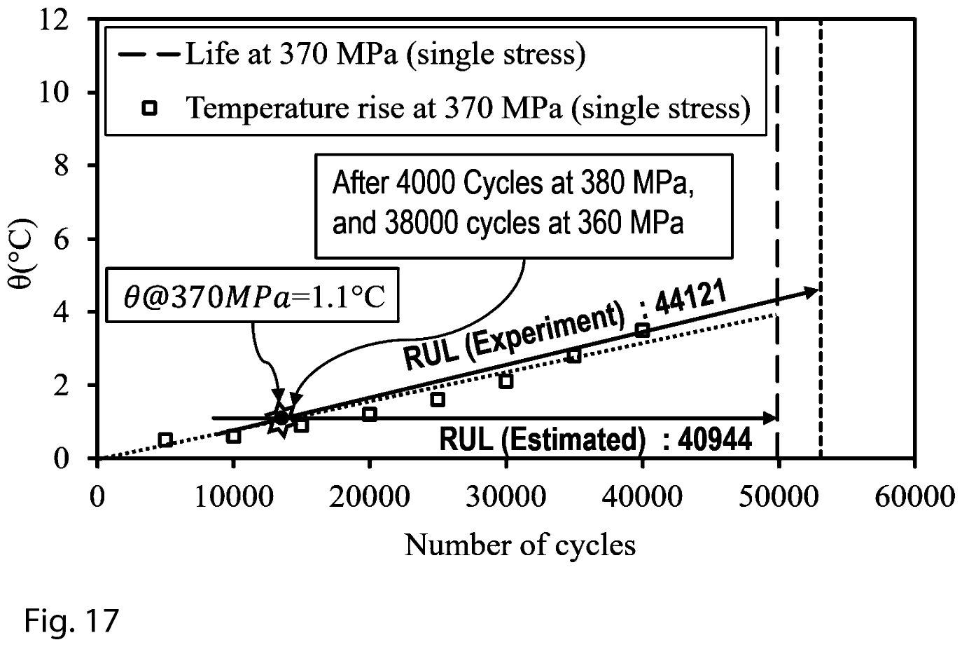

In case VII variable loading from high-to-low-to-high stress (from 380 to 360 to 370 MPa) was evaluated. A three-step variable load was applied in this case. The specimen was subjected to 4,000 fatigue cycles at 380 MPa, followed by 38,000 load cycles at 360 MPa before undergoing fatigue stress of 370 MPa. FIG. 17 depicts an evaluation of the remaining useful life for a high-to-low-to-high stress case (380 to 360 to 370 MPa). As shown in FIG. 17, the temperature rise after 5,000 cycles at 370 MPa was 1.1° C., equivalent to the damage value of ω_{E,N}=0.28. Therefore, considering the cycles needed to reach the steady state, the RUL at the beginning of the 3rd step of loading is predicted to be 40,934 cycles. The experimental result for RUL is 44,121 cycles, less than 8% error compared to the predicted RUL.

The results of different variable amplitude cases summarized in Table 4 show that the estimated results are in an acceptable margin of error (less than 10%). The negative values for the margin of error belong to the conservative predictions. Contrary to Miner's rule, which is unable to consider the loading sequence, in this method, the load sequence affects the rate of damage growth and, consequently, the temperature rise. Therefore, the predictions of this method are in good agreement with the experimental ones for both low-to-high and high-to-low-stress fatigue cases.

TABLE 4
Summary of the results of remaining useful
life (RUL) for different load cases

| | | Estimated | Experimental | Error |
|---|---|---|---|---|
| Load Case | Stress (MPa) | RUL | RUL | (%) |
| I. Constant Amplitude | 370 | 26856 | 24900 | 7.8 |
| II. Constant Amplitude | 360 | 132484 | 124800 | 6.1 |
| III. Constant Amplitude | 340 | 627152 | 585200 | 7.2 |
| III. Constant Amplitude | 340 (damage | 643500 | 585200 | 9.9 |
| | evaluation | | | |
| | at 360 MPa) | | | |
| IV. High-to-Low | 370 to 360 | 74732 | 74074 | 0.9 |
| V. Low-to-High | 360 to 370 | 31098 | 34144 | −8.9 |
| VI. Low-to-High- | 360 to 380 | 35339 | 38121 | −7.3 |
| to-Low | to 370 | | | |
| VII. High-to-Low- | 380 to 360 | 40944 | 44121 | −7.2 |
| to-High | to 370 | | | |

The experimentally verified procedure may be used to estimate the remaining useful life by measuring the temperature rise during fatigue. Two different damage parameters based on toughness reduction and entropy accumulation are developed using the temperature rise during the steady-state phase of fatigue. The comparison between damage parameters shows that the concept of fracture fatigue entropy (FFE) is more useful and more convenient for evaluating the damage state of the material. The toughness-based damage parameter is highly sensitive, and even a small 1 percent miscalculation in its estimation can result in significant inaccuracies when predicting the remaining useful life. Conversely, the entropy-based damage parameter offers greater stability, and its damage growth rate remains consistent regardless of the number of cycles until failure.

The CS1018 specimens are subjected to a repetitive Run-Stop-Cooldown (RSC) procedure to investigate the changes in the temperature rise of the steady-state phase. The results show that the stabilized temperature increases after each pause in the fatigue procedure, and it is a linear function of the number of fatigue cycles. This relation is used to estimate the remaining useful life of CS 1018 without knowing the loading history. The idea of gradual accumulating entropy until fracture is employed to estimate the damage value by leveraging the stabilized temperature. The accumulated entropy is harnessed to evaluate the material's capacity to generate entropy, thereby allowing the prediction of the remaining useful life for components experiencing fatigue.

The application of the method was examined in various loading conditions, including three different constant amplitude and four different variable amplitude cases. The test cases include high-to-low, low-to-high, low-to-high-to-low, and high-to-low-to-high stresses. First, the damage parameter is determined by measuring the temperature rise at a specific loading condition. Then the damage parameter is used to estimate the remaining life using the concept of FFE. The comparison between the estimated and experimental results shows that the method is applicable in both low- and high-cycle fatigue regimes. The method is capable of reliable prediction of remaining life in constant and variable amplitude cases with an error of less than 10%.

FIG. 18 depicts an embodiment in which the fatigue assessments described herein may be applied. A specimen 20 is held by two grips 50, which apply the cyclical fatigue of the type described above. A resistance temperature detector 40 senses temperature readings from a region of greatest temperature elevation 43 experienced during fatigue. A type K thermocouple 48 measures a reference temperature in a remote area 46 representative of the stabilized unstressed temperature associated with the region of greatest temperature elevation 43. A data acquisition system 53 acquires and records the temperature data from the resistance temperature detector 40 and the thermocouple 48 for evaluation and characterization of the fatigue life by computer 56 utilizing the methods described herein.

The experiments conducted herein demonstrate a technique for the evaluation of remaining useful life with significant potential for a variety of applications beyond the specific testing conditions described. The following examples demonstrate how individual concepts may be applied in contexts with lesser degrees of precision, lesser intensities of monitoring, and lower degrees of certainty regarding the nature of the mechanical stresses involved.

Because generalized service records are often available for mechanical devices indicating hours of service or other parameters that are insufficient for fatigue life progression characterization, the techniques described herein may be used in conjunction with those generalized service records to indicate or find deviations from expected stress magnitudes in the history of the mechanical device. For example, methods used herein could be used to determine that a turbine blade has less than 10% of its remaining useful life remaining while at the same time, hours-of-operation logs may indicate that the blade has over 60% of its remaining useful life available. This type of information can serve as the basis for both maintenance decisions and as an alarm/indication for further investigation into the causes of the unexpectedly low remaining useful life. Mechanical objects that are theoretically representative of a larger group of similarly situated mechanical objects can be set up for intermittent testing or continuous monitoring to trigger wider testing, investigation, and related maintenance actions.

As that phrase is used herein, “stress magnitude” encompasses any magnitude of stress that can be sufficiently quantified to serve directly as a stress amplitude level (MPa) for a set of conditions or a function equivalent to the stress amplitude level (MPa) for a set of conditions. Alternate examples include running a machine with a mechanical object being evaluated at 80% load or at 100% load. Characterizations of this variety and other equivalents are likely more useful in industrial context and context where the applied stress amplitude has complexities such as mixtures of types of stress more easily quantifiable in the combined form of a stress magnitude. Changes in stress magnitude can also encompass changes to the mode of delivery of stress including for example switching from a stress that is predominantly tension-compression and secondarily torsion to a stress that is predominantly torsion and secondarily tension-compression. In such cases the stress dependent damage parameters for the mechanical object should match the stress that is being used to evaluate a fatigue life progression characterization or the remaining useful life. Further, the changes to the mode of delivery of stress may alter the fatigue life progression characterization such that full characterization of a fatigue life progression characterization in a first mode of delivery of stress may indicate 60% of the useful life remains and a fatigue life progression characterization in a second mode of delivery of stress may indicate 70% of the useful life remains. Validation of individual techniques applied along with use of appropriate stress dependent damage parameters for the mechanical object, including consideration of the mode of delivery of stress in the evaluation of the stress dependent damage parameters for the mechanical object, should allow a practitioner to determine if the techniques described herein are adequate to serve the accuracy needs of a particular application. In many cases where the accuracy is inadequate, a more careful determination of the stress dependent damage parameters for the mechanical object that is a better match to the new stress magnitude may achieve the required accuracy.

The phrase “mechanical object” is intended to encompass a wide range of objects and equipment of various materials including metals, plastics, and composites. Rotating machinery, turbines, turbine blades, mixing blades, windmill components, pressure vessels, pipes, and welds are all examples of items within the scope of the phrase mechanical object.

As that phrase is used herein, “stabilized stressed temperature” is the seemingly steady-state temperature measured in the region of greatest temperature elevation. The term “steady-state” as used herein involves temperatures and temperature differentials that on a short time scale appear to be unchanging, but on a long enough time scale the steady-state is better represented by a slow approximately linear rise in temperature.

As that phrase is used herein, “region of greatest temperature elevation” is that portion of a mechanical object that contains the highest heat during fatigue and is within sufficient proximity to the location of the highest heat during fatigue that the application of the methods herein may be used to predict the remaining useful life of the mechanical object. The region of greatest temperature elevation, such as the central barrel of the test specimens may be evaluated and selected based on failure analysis, computer modeling, experience, or other comparable methods.

As that phrase is used herein, “reference temperature” is a temperature that is representative of the fully cooled equilibrium temperature of the region of greatest temperature elevation. In cases where the reference temperature is in the region of greatest temperature elevation the reference temperature should be taken at a practical time reasonably close to the time of recording the stabilized stressed temperature. The reference temperature need not be in the region of greatest temperature elevation and may for example be measured at a nearby location either on the mechanical object or adjacent to the mechanical object being tested. If such a remote location is selected it should be selected based on that remote location being representative of the ambient cooled condition of the region of greatest temperature elevation.

As that phrase is used herein “temperature differential” in its various forms represents the difference between the stabilized stressed temperature at the region of greatest temperature elevation and the reference temperature. 0 is an example of temperature differential, but the concept is open to a wide range of types of temperature measurement and the various types of reference temperatures that may be used. As depicted in FIG. 1 temperature differential is measured during Phase II where the temperature differential is not accelerating relative to the increment of fatigue stress. The term “accelerating” is used in a comparable manner to positional acceleration being the second derivative of position with respect to time. In the experiments conducted, during Phase II the second derivative of θ with respect to cycles is essentially zero. As before, characterizations of “steady-state” as used herein involves temperatures and temperature differentials that on a short time scale appear to be unchanging, but on a long enough time scale the steady-state is better represented by a slow approximately linear rise in temperature.

As that phrase is used herein, “stress dependent stable temperature differential transition value” represents the two temperature differential values that represent the temperature differential transitions in and out of Phase II as depicted in FIG. 1. Examples include θ₀ and θ_{f}. Additional examples include temperature differentials based on reference temperatures taken at more remote locations.

As that phrase is used herein, “partial temperature differential progression value” represents a difference between temperature differentials when one temperature differential is a current temperature differential, such as θ_{N}, and another temperature differential is a stress dependent stable temperature differential transition value, such as either θ₀ or θ_{f}. For example, (θ_{N}−θ₀) as it appears as part of Equation 9 would be a partial temperature differential progression value.

As that phrase is used herein, “stress dependent full stable temperature progression difference” represents the difference between the two stress dependent stable temperature differential transition values. (θ_{f}−θ₀) would be an example. Similarly, although an unconventional formulation, (θ₀−θ_{f}) would be another example.

As that phrase is used herein, “fatigue life progression characterization” is any characterization that would represent the status of progress toward a mechanical failure in the useful life of a mechanical object for a particular level of stress. For example, the expression

$$\frac{{θ}_{N} - {θ}_{0}}{{θ}_{f} - {θ}_{0}}$$

as found in Equation 9 would be an example of a fatigue life progression characterization. Percentages of useful life consumed or remaining would also be examples of fatigue life progression characterization. The number of cycles to failure would also be a fatigue life progression characterization.

As that phrase is used herein, “increment of fatigue stress” represents a unit such as time or cycles over which comparable stresses occur on a mechanical object. The experimental methods are described in terms of cycles. However, the repetition of similar stresses may occur under a variety of measurable increments. Accordingly, the methods described herein could be applied to increments such as hours of operation, number of motor starts, or even a number of duty cycles where each duty cycle includes a series of differentiated stresses but in which each completed duty cycle has a comparable impact from a damage perspective.

As that phrase is used herein, “stress dependent damage parameters for the mechanical object” indicates the damage related parameters associated with a mechanically equivalent object from a fatigue life progression perspective which may be used to determine a fatigue life progression characterization at a stress magnitude for a mechanical object based on a temperature differential occurring during the progress of the fatigue life of a mechanical object at the stress magnitude. The stress dependent damage parameters for the mechanical object may be derived from testing, interpolation of testing data including nonlinear interpolation, computer modeling, or combinations thereof. Examples of stress dependent damage parameters for the mechanical object include the values listed at the various stress levels for N_{f}, C, θ₀, and θ_{f}.

As that phrase is used herein, the “stable temperature differential slope” is the slope of the temperature differential line in Phase II of FIG. 1 generalized such that increments of fatigue stress other than C (° C./cycle) may be used with the temperature differential.

The above-described embodiments have a number of independently useful individual features that have particular utility when used in combination with one another including combinations of features from embodiments described separately. There are, of course, other alternate embodiments which are obvious from the foregoing descriptions, which are intended to be included within the scope of the present application.

We claim:

1. A method of evaluating mechanical damage comprising:
a. applying a repeated stress having a stress magnitude to a mechanical object until the repeated stress results in a stabilized stressed temperature in a region of greatest temperature elevation within the mechanical object caused by the repeated stress at a time;
b. measuring the stabilized stressed temperature at the time;
c. measuring a reference temperature associated with the time;
d. calculating a temperature differential associated with the time from the stabilized stressed temperature and the reference temperature associated with the time;
e. calculating a fatigue life progression characterization utilizing the temperature differential associated with the time and two or more stress dependent damage parameters for the mechanical object;
f. wherein the measuring of the stabilized stressed temperature is under a set of prevailing conditions;
g. wherein the stabilized stressed temperature is a non-accelerating temperature;
h. wherein the reference temperature is associated with the mechanical object and representative of a stabilized unstressed temperature of the mechanical object within the region of greatest temperature elevation under an equivalent resting condition.

2. The method of evaluating mechanical damage of claim 1 further comprising:
a. evaluating the difference between the temperature differential associated with the time and a first stress dependent stable temperature differential transition value to obtain a partial temperature differential progression value and
b. comparing the partial temperature differential progression value to a stress dependent full stable temperature progression difference.

3. The method of evaluating mechanical damage of claim 1, wherein the stabilized unstressed temperature is a constant temperature in which the mechanical object is allowed to fully cool under the set of prevailing conditions.

4. The method of evaluating mechanical damage of claim 1, wherein the equivalent resting condition is a condition of the mechanical object in which the mechanical object is allowed to cool without application of stress to the mechanical object under the set of prevailing conditions at the time of the repeated stress.

5. The method of evaluating mechanical damage of claim 1, wherein a fatigue history of the mechanical object is unknown.

6. The method of evaluating mechanical damage of claim 1, wherein a stable temperature differential slope is used to calculate the fatigue life progression characterization.

7. A machine for evaluating damage comprising:
a. a first temperature measurement device attached to a region of greatest temperature elevation on a mechanical object;
b. a second temperature measurement device attached at a location remote from the region of greatest temperature elevation;
c. a data acquisition system capable of receiving an input representative of the stress magnitude;
d. a data storage component storing stress dependent damage parameters for the mechanical object;
e. a processing system capable of identifying a stabilized stressed temperature from data obtained from the first temperature measurement device and data obtained from the second temperature measurement device;
f. wherein the processing system is arranged and configured to evaluate and communicate a fatigue life progression characterization.

8. The machine for evaluating damage of claim 7, wherein the fatigue life progression characterization is calculated without benefit of a prior fatigue history of the mechanical object.

9. The machine for evaluating damage of claim 7, wherein a stable temperature differential slope is used to calculate the fatigue life progression characterization.

10. The machine for evaluating damage of claim 7, wherein the processing system evaluates a partial temperature differential progression value.

11. The machine for evaluating damage of claim 10, wherein the processing system compares a stress dependent full stable temperature differential progression difference to the partial temperature differential progression value.
